(19) United States
(12) Patent Application Publication
(10) Pub. No.: US 2009/0324127 A1
(43) Pub. Date: Dec. 31, 2009

(54) Method and System for Automatic Red-Eye Correction

(76) Inventor: Madhukar Budagavi, Plano, TX (US)

Correspondence Address: TEXAS INSTRUMENTS INCORPORATED, P O BOX 655474, M/S 3999, DALLAS, TX, 75265, US

(21) Appl. No.: 12/165,367

(22) Filed: Jun. 30, 2008

(51) Int. Cl. G06K 9/80

(52) U.S. Cl. 382/275

(57) ABSTRACT

Methods and systems are provided for automatic red-eye correction in digital images in which the location of red eyes in a digital image is detected, the red eyes in the digital image are corrected by restoring the red eyes to their natural color; and the corrected digital image is displayed.

### BACKGROUND OF THE INVENTION

Red-eye, the appearance of an unnatural reddish coloration of the pupils of a subject appearing in an image, is a frequently occurring problem in flash photography. Redeye is caused by light from the flash reflecting off blood vessels in the subject's retina and returning to the camera. Typically, digital cameras incorporate automatic red-eye detection and correction algorithms to help alleviate the red-eye occurrences. A typical red-eye detection and correction algorithm includes three basic steps: face detection, red-eye detection, and red-eye correction. The face detection step involves detecting facial regions in the given input image using algorithms such as those proposed in P. Viola and M. Jones, “Robust real-time object detection,” ICCV Workshop Statistical Comp. Theories of Vision, 2002. The output of this step is the location of the face in the input image. The red-eye detection step then uses the face location to detect red-eyes within the facial region based on redness information and redness variation within image areas corresponding to the detected eye locations. The output of the red-eye detection step is the location of the red-eyes in the input image. The red-eye correction step uses the red-eye location to correct the red-eyes. This correction is typically done by a process called desaturation which reduces or eliminates the chrominance information in the regions of the detected red-eye.

The equations for desaturation are given by:

Y_{corrected}(x,y)=Y_{orig}(x,y)

Cr_{corrected}(x,y)=αCr_{orig}(x,y)

Cb_{corrected}(x,y)=βCb_{orig}(x,y) (1)

or by

Y_{corrected}(x,y)=Y_{orig}(x,y)

Cr_{corrected}(x,y)=c

Cb_{corrected}(x,y)=c (2)

where Y_{orig}(x,y), Cb_{orig}(x,y), Cr_{orig}(x,y) are the Y, Cb, Cr values of the pixel at location (x,y) in the original image. Y_{corrected}(x,y), Cb_{corrected}(x,y), Cr_{corrected}(xy) denote the corresponding red-eye corrected Y, Cb, Cr values. In Equation (1), selecting α,β<1 reduces the amount of red-eye. In equation (2), c=128 eliminates the chrominance information.

When equations (1) and (2) are used for red-eye correction, the natural color of the eyes may be lost. If the red-eye effect is slight and covers only the pupil, red-eye correction by using equations (1) or (2) may provide acceptable visual quality. However, if the red-eye is more severe and bleeds into the neighboring iris region, this approach to red-eye correction may destroy the natural color of the iris.

### SUMMARY OF THE INVENTION

Embodiments of the invention provide methods and system for automatic red-eye correction in digital images in which the red eyes are restored to their natural color. More specifically, embodiments of the invention use face recognition to identify the face of the person in the picture having the red eyes in order to locate an iris template corresponding to the face. The iris template, which includes the natural color of the irises of that person, is used to restore the natural color to the irises of the red eyes in the digital image.

### BRIEF DESCRIPTION OF THE DRAWINGS

Particular embodiments in accordance with the invention will now be described, by way of example only, and with reference to the accompanying drawings:

FIGS. 1A and 1B show block diagrams of illustrative digital systems in accordance with one or more embodiments of the invention;

FIG. 2 shows an image pipeline in accordance with one or more embodiments of the invention;

FIG. 3 shows a block diagram of a red-eye correction system in accordance with one or more embodiments of the invention;

FIG. 4 shows a flow diagram of a method for red-eye correction in accordance with one or more embodiments of the invention; and

FIG. 5 shows an illustrative digital system in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

In general, embodiments of the invention provide methods and systems for automatic correction of red eyes in digital images in which the irises of the red eyes are restored to their natural color. More specifically, embodiments of the invention provide for red-eye correction in which the location of red eyes in a digital image is detected, face recognition is performed to identify the face in which the red eyes are located, and an iris template corresponding to the identified face is used to restore the natural color of the irises in the red eyes. Further, in one or more embodiments of the invention, the face is located in the digital image and face alignment and extraction is performed to normalize the face before face recognition is performed. In some embodiments, the face alignment and extraction uses both the location of the face in the digital image and the location of the red eyes to perform the normalization.

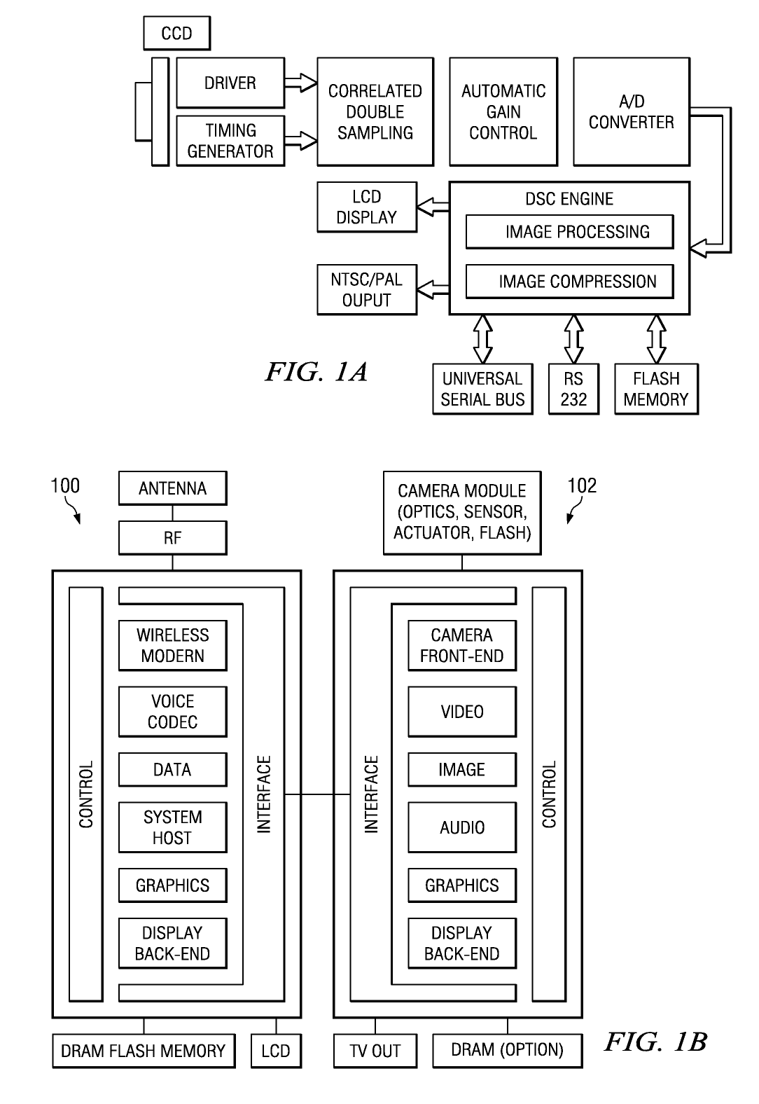

FIGS. 1A and 1B are examples of digital systems that may include systems and methods for automatic red-eye correction as described below. Specifically, FIG. 1A is a block diagram of a digital still camera (DSC) in accordance with one or more embodiments of the invention and FIG. 1B is a block diagram of a multimedia-enabled cellular telephone.

The DSC of FIG. 1A includes a CCD/CMOS imager to sense images and Driver circuitry and the Timing Generator circuitry to generate the signals for clocking the CCD. Correlated Double Sampling and Automatic Gain Control circuitry included in the DSC provide functionality to acquire a good-quality signal form the CCD sensor. The data from the CCD sensor digitized by the A/D Converter and provided to a DSC Engine, which may be a digital signal processor (DSP). The DSC Engine performs the required image processing and image compression operations. In embodiments of the invention, the DSC Engine also performs automatic red-eye correction as described herein. A stored software program in an onboard or external memory may be executed to implement the automatic red-eye correction. The DSC also includes an LCD display for displaying captured images and a Flash Memory for storing the captured images. In some embodiments of the invention, the DSC also includes an NTSC/PAL Output for viewing or previewing the captured images on external display devices. Further, in one or more embodiments of the invention, the DSC includes a Universal Serial Bus (USB) port and/or an RS232 port for connecting to external devices such as personal computers and printers.

The cellular telephone of FIG. 1B includes a baseband communications chip (100) and a multimedia coprocessor chip (102). The baseband communications chip (100) implements the wireless modem functions while the multimedia coprocessor chip (102) implements the imaging, video, and other multimedia technology. More specifically, the baseband communications chip (100) interfaces with the antenna and RF electronics and performs all communications processing, voice and data processing, system control, graphics, and display of system control on the liquid crystal display (LCD). The multimedia coprocessor chip (102) interfaces with the camera module and performs all of the image/video and audio processing. The multimedia coprocessor chip (102) may also process graphics and provide display back-end capability.

The multimedia coprocessor chip (102) includes functionality for the generation of pictures (i.e., digital images) by applying various image processing steps and algorithms to raw image data from the camera module. The multimedia coprocessor chip (102) may be a system on a chip (SOC) that includes a hardware signal processor (e.g., a hardwired processing unit, an imaging accelerator, and/or a general purpose processor), 3A (automatic exposure, automatic white balance, and automatic focus) algorithms and application software, a codec, a display controller, and a flash memory controller or hardwired circuitry that includes a sensor interface, an image pipeline, and a 3A engine. In one or more embodiments of the invention, the multimedia coprocessor chip (102) also performs automatic red-eye correction as described herein. A stored software program in an onboard or external memory may be executed to implement the automatic red-eye correction.

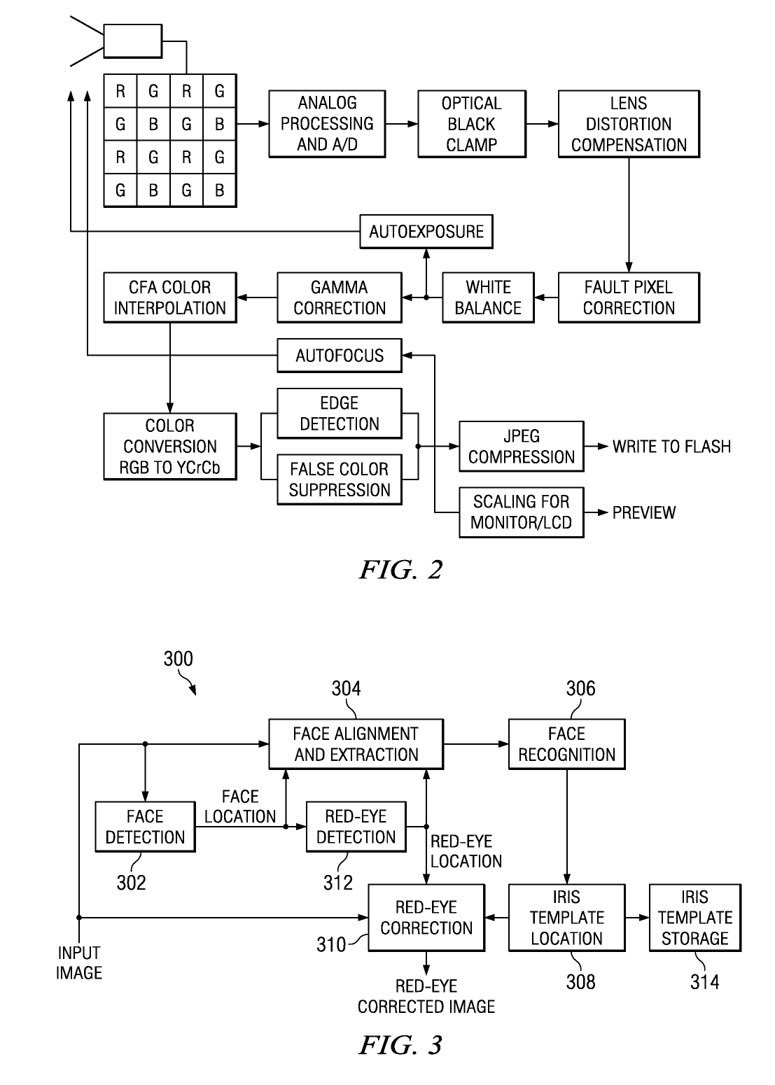

FIG. 2 is a block diagram illustrating digital camera control and image processing (the “image pipeline”) in accordance with one or more embodiments of the invention. One of ordinary skill in the art will understand that similar functionality may also be present in other digital devices (e.g., a cell phone, pda, etc.) capable of capturing digital images. The automatic focus, automatic exposure, and automatic white balancing are referred to as the 3A functions; and the image processing includes functions such as color filter array (CFA) interpolation, gamma correction, white balancing, color space conversion, and JPEG/MPEG compression/decompression (JPEG for single images and MPEG for video clips). A brief description of the function of each block in accordance with one or more embodiments is provided below. Note that the typical color CCD consists of a rectangular array of photosites (pixels) with each photosite covered by a filter (the CFA): typically, red, green, or blue. In the commonly-used Bayer pattern CFA, one-half of the photosites are green, one-quarter are red, and one-quarter are blue.

To optimize the dynamic range of the pixel values represented by the CCD imager of the digital camera, the pixels representing black need to be corrected since the CCD cell still records some non-zero current at these pixel locations. The black clamp function adjusts for this difference by subtracting an offset from each pixel value, but clamping/clipping to zero to avoid a negative result.

Imperfections in the digital camera lens introduce nonlinearities in the brightness of the image. These nonlinearities reduce the brightness from the center of the image to the border of the image. The lens distortion compensation function compensates for the lens by adjusting the brightness of each pixel depending on its spatial location.

Large-pixel CCD arrays may have defective pixels. The fault pixel correction function interpolates the missing pixels with an interpolation scheme to provide the rest of the image processing data values at each pixel location.

The illumination during the recording of a scene is different from the illumination when viewing a picture. This results in a different color appearance that is typically seen as the bluish appearance of a face or the reddish appearance of the sky. Also, the sensitivity of each color channel varies such that grey or neutral colors are not represented correctly. The white balance function compensates for these imbalances in colors by computing the average brightness of each color component and by determining a scaling factor for each color component. Since the illuminants are unknown, a frequently used technique just balances the energy of the three colors. This equal energy approach requires an estimate of the unbalance between the color components.

Due to the nature of a color filtered array, at any given pixel location, there is only information regarding one color (R, G, or B in the case of a Bayer pattern). However, the image pipeline needs full color resolution (R, G, and B) at each pixel in the image. The CFA color interpolation function reconstructs the two missing pixel colors by interpolating the neighboring pixels.

Display devices used for image-viewing and printers used for image hardcopy have a nonlinear mapping between the image gray value and the actual displayed pixel intensities. The gamma correction function compensates for the differences between the images generated by the CCD sensor and the image displayed on a monitor or printed into a page.

Typical image-compression algorithms such as JPEG operate on the YCbCr color space. The color space conversion function transforms the image from an RGB color space to a YCbCr color space. This conversion is a linear transformation of each Y, Cb, and Cr value as a weighted sum of the R, G, and B values at that pixel location.

The nature of CFA interpolation filters introduces a low-pass filter that smoothes the edges in the image. To sharpen the images, the edge detection function computes the edge magnitude in the Y channel at each pixel. The edge magnitude is then scaled and added to the original luminance (Y) image to enhance the sharpness of the image.

Edge enhancement is only performed in the Y channel of the image. This leads to misalignment in the color channels at the edges, resulting in rainbow-like artifacts. The false color suppression function suppresses the color components, Cb and Cr, at the edges reduces these artifacts.

The autofocus function automatically adjusts the lens focus in a digital camera through image processing. These autofocus mechanisms operate in a feedback loop. They perform image processing to detect the quality of lens focus and move the lens motor iteratively until the image comes sharply into focus.

Due to varying scene brightness, to get a good overall image quality, it is necessary to control the exposure of the CCD. The autoexposure function senses the average scene brightness and appropriately adjusting the CCD exposure time and/or gain. Similar to autofocus, this operation is also in a closed-loop feedback fashion.

Most digital cameras are limited in the amount of memory available on the camera; hence, the image compression function is employed to reduce the memory requirements of captured images. Typically, compression ratios of about 10:1 to 15:1 are used. In one or more embodiments of the invention, red-eye correction as described herein may be performed as a pre-preprocessing step prior to image compression or as a post-processing step after image compression.

FIG. 3 shows a block diagram a system for automatic red-eye correction in accordance with one or more embodiments of the invention. The system (300) includes face detection logic (302), face alignment and extraction logic (304), face recognition logic (306), iris template location logic (308), red-eye correction logic (310), red-eye detection logic (312) and iris template storage (314).

The face detection logic (302) includes functionality to locate the face of a person in a digital image. The face detection logic (302) may use any suitable technique for face detection. A suitable technique may include, but is not limited to, the face detection technique described in P. Viola and M. Jones, “Robust real-time object detection,” ICCV Workshop Statistical Comp. Theories of Vision, 2002. The output of the face detection logic (302) is information regarding the location of the face in the digital image. In some embodiments of the invention, this information may describe a bounding box, i.e., a rectangular area in the digital image that contains the detected face.

The red-eye detection logic (312) includes functionality to detect red eyes, if any, in the face location provided by the face detection logic (302). The red-eye detection logic (312) may use any suitable technique for red-eye detection. Suitable techniques may include, but are not limited to, the red-eye detection techniques described in H. Luo et al., “An efficient automatic redeye detection and correction algorithm,” Proc. 17^{th} Intl. Conf. Pattern Recognition (ICPR'04), M. Gaubatz and R. Ulichney, “Automatic red-eye detection and correction,” Proc. IEEE Intl. Conf. Image Processing (ICIP), pp. 804-807, 2002, and A. Patti et al., “Automatic digital red-eye detection and correction algorithm,” Proc. IEEE Intl. Conf. Image Processing (ICIP), pp. 55-59, 1998. The output of the red-eye detection logic (312) is information regarding the location of the red eyes in the digital image. In some embodiments of the invention, this information may describe a bounding box containing the red eyes.

The face location provided by the face detection logic (302) includes a face but that face may not be centered and may be too large or too small to be used effectively by the face recognition logic (306). The face alignment and face extraction logic (304) includes functionality to normalize the face (i.e. rotate and scale the face so that the face is aligned properly and is of the right size) to an appropriate resolution for face recognition. In one or more embodiments of the invention, the face alignment and face extraction logic (304) uses both the face location provided by the face detection logic (302) and the red-eye location provided by the red-eye detection logic (312). Having the location of the red eyes as well as the face location simplifies the normalization process as once the location of the eyes is known, it is easier to center the face. The output of the face alignment and face extraction logic (304) is a bounding box containing the normalized, aligned face.

The face recognition logic (306) includes functionality to identify (i.e., recognize) the normalized face provided by the face alignment and extraction logic (304). The face recognition logic (306) may use any suitable technique for face recognition. A suitable technique may include, but is not limited to, the face recognition technique described in P. Belhumeur, et al., “Eigenfaces vs. Fisherfaces: Recognition Using Class Specific Linear Projection,” IEEE Transactions on Pattern Analysis and Machine Intelligence, Special issue on face recognition, pp. 711-720, July, 1997. The output of the face recognition logic (306) is information regarding the identified face to be used by the iris template location logic (308) to locate an iris template corresponding to the identified face. In some embodiments of the invention, this information may be an index of an iris template corresponding to the identified face stored in the iris template storage (314) described below.

In one or more embodiments of the invention, the face recognition logic (306) is trained to recognize the faces of people who will be the subjects of digital images processed by the system (300). Training the face recognition logic (306) includes providing at least one digital image of each person to the face recognition logic. For example, the owner of a digital camera may take a picture of a person and invoke a function on the camera that causes the face recognition logic (306) to be trained to recognize the face of that person. In some embodiments of the invention, the digital image of the person used for training may be the same digital image that is used to generate the iris template for that person. Generation of iris templates is described in more detail below. Further, in one or more embodiments of the invention, the picture of the person may be transferred form the digital camera to another digital system such as a personal computer or laptop, where the face recognition training is performed. The parameters from the training may then be transferred from the digital system to the face recognition logic (306) to configure the face recognition logic (306) to recognize the face of that person.

The iris template storage (314) stores iris templates corresponding to the irises of people who will be the subjects of digital images processed by the system (300). The iris template storage (314) may be any suitable storage including, but not limited to a database, a file system, one or more data structures in a memory or storage device, or any combination thereof. An iris template includes a digital image of irises (with the embedded pupils) that are the natural color irises (with no red-eye degradation) of a person.

The iris templates may be created from digital images of the people in which the people do not have red eyes. For example, a user of a digital camera may take pictures of himself and other potential subjects (e.g., his family) under controlled lighting without using a flash so that the resulting digital images do not have red eyes. A software program may then be used to extract the irises from these digital images to create the iris templates and store them in the iris template storage (314). In some embodiments of the invention, the software program may be executed on the system (200). In one or more embodiments of the invention, the software program may be executed on a system other than the system used to capture the digital images and/or the system that includes the iris template storage (314). As previously explained, the digital images used to create the iris templates may also be used to train the face recognition logic (306).

The iris template location logic (308) includes functionality to use the information regarding the identified face from the face recognition logic (306) to locate the iris template corresponding to the identified face in the iris template storage (314). In one or more embodiments of the invention, the information regarding the identified face is an index that the iris template location logic (308) uses to search the iris template storage (314) to locate the corresponding iris template. For example, there may be n iris templates stored in an array in the iris template storage (314), one of for each of n faces that the face recognition logic (306) is trained to identify. The index provided by the face recognition logic (306) may be a number between 1 and n that the iris template location logic (308) may use as an index for the entry in the array holding the iris template corresponding the identified face.

The red-eye correction logic (310) includes functionality to correct the red eyes in the digital image using the iris template provided by the iris template location logic (308). More specifically, the red-eye correction logic (310) replaces pixels in the irises in the red-eye degraded portion (i.e., in the red-eye location provided by the red-eye detection logic (312)) of the digital image with the natural color pixels from the iris template. In some embodiments of the invention, the red-eye correction logic (310) may also include functionality to smooth over the corrected red-eye region for continuity and or to normalize the region for illumination level. The output of the red-eye correction logic (310) is a red-eye corrected digital image in which natural eye color is restored. This corrected digital image may then be displayed and/or stored.

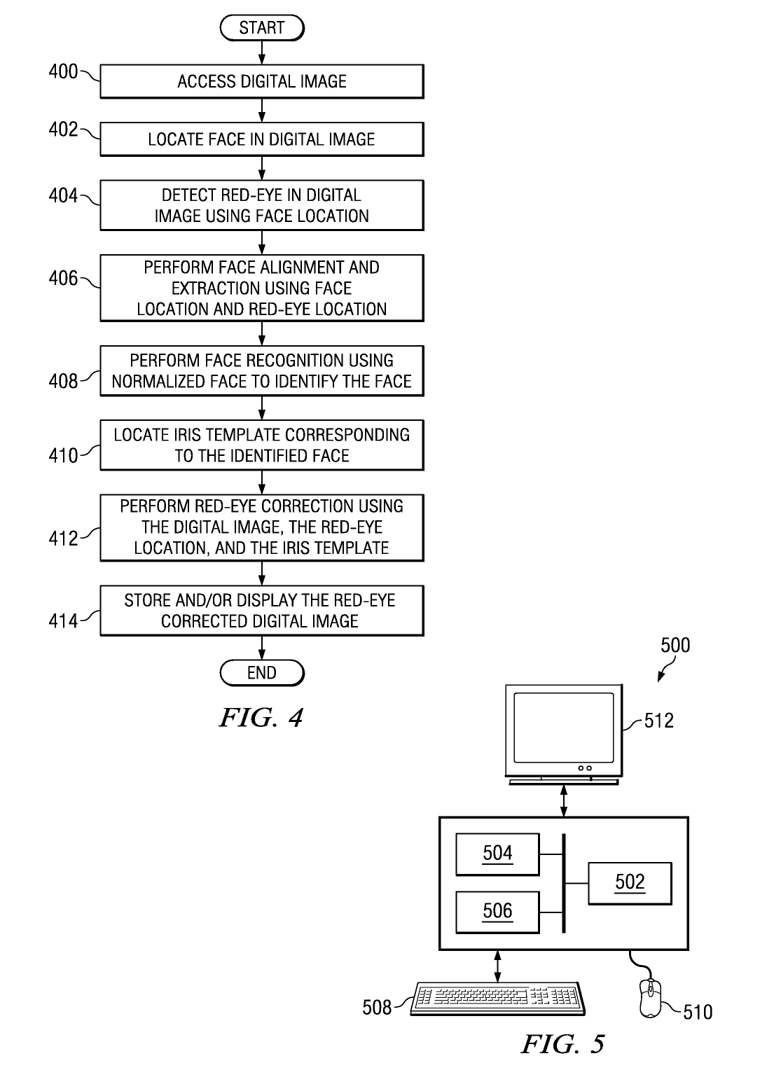

FIG. 4 shows a flow diagram of a method for automatic correction of red eyes in a digital image to their natural color in accordance with one or more embodiments of the invention. In the method, initially a digital image is accessed (400). The digital image may be accessed, for example, by receiving the digital image from an image capture device or reading the digital image from a memory or storage device.

A face is then located in the digital image (402). As previously explained, any suitable technique for locating a face in a digital image may be used. Once the face is located, red-eyes, if any are present, are detected in the digital image (404). Again, as previously explained, any suitable technique for detecting red eyes in a digital image may be used.

Once the face is located and the red eyes are detected, face alignment and extraction is performed using the face location and the red-eye location (406). Face alignment and extraction normalizes the face to a resolution suitable for use in face recognition. After the located face is normalized, face recognition is performed using the normalized face to identify the face. As previously described, any suitable technique for face recognition may be used. Also, the face recognition may be trained to recognize the faces of people who will be subjects of digital images to be processed using this method. In one or more embodiments of the invention, the output of the face recognition may be an index of an iris template corresponding to the identified face.

Once the face is identified, the iris template corresponding to the identified face is located (410). The located iris template is subsequently used to perform red-eye correction on the digital image (412). In one or more embodiments of the invention, the red-eye correction replaces the pixels in the red eye location of the digital image with the natural color pixels from the irises in the iris template to restore the natural color of the irises in the digital image. The red-eye corrected image may then be stored and/or displayed (414).

Embodiments of the automatic red-eye correction methods and systems described herein may be implemented on virtually any type of digital system (e.g., a desk top computer, a laptop computer, a handheld device such as a mobile (i.e., cellular) phone, a personal digital assistant, a digital camera, an MP3 player, an iPod, etc.). Further, embodiments may include a digital signal processor (DSP), a general purpose programmable processor, an application specific circuit, or a system on a chip (SoC) such as combinations of a DSP and a RISC processor together with various specialized programmable accelerators. For example, as shown in FIG. 5, a digital system (500) includes a processor (502), associated memory (504), a storage device (506), and numerous other elements and functionalities typical of today's digital systems (not shown). In one or more embodiments of the invention, a digital system may include multiple processors and/or one or more of the processors may be digital signal processors. The digital system (500) may also include input means, such as a keyboard (508) and a mouse (510) (or other cursor control device), and output means, such as a monitor (512) (or other display device). The digital system ((500)) may also include an image capture device (not shown) that includes circuitry (e.g., optics, a sensor, readout electronics) for capturing digital images. The digital system (500) may be connected to a network (514) (e.g., a local area network (LAN), a wide area network (WAN) such as the Internet, a cellular network, any other similar type of network and/or any combination thereof) via a network interface connection (not shown). Those skilled in the art will appreciate that these input and output means may take other forms.

Further, those skilled in the art will appreciate that one or more elements of the aforementioned digital system (500) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources.

Software instructions to perform embodiments of the invention may be stored on a computer readable medium such as a compact disc (CD), a diskette, a tape, a file, or any other computer readable storage device. The software instructions may be a standalone program, or may be part of a larger program (e.g., a photo editing program, a web-page, an applet, a background service, a plug-in, a batch-processing command). The software instructions may be distributed to the digital system (500) via removable memory (e.g., floppy disk, optical disk, flash memory, USB key), via a transmission path (e.g., applet code, a browser plug-in, a downloadable standalone program, a dynamically-linked processing library, a statically-linked library, a shared library, compilable source code), etc. The digital system (500) may access a digital image by reading it into memory from a storage device, receiving it via a transmission path (e.g., a LAN, the Internet), etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method of performing automatic red-eye correction on a digital image, the method comprising:
detecting a location of red eyes in the digital image;
correcting the red eyes in the digital image by restoring the red eyes to their natural color; and
displaying the corrected digital image.

2. The method of claim 1, wherein restoring the red eyes further comprises replacing pixels in irises of the red eyes with pixels from an iris template corresponding to a face comprising the red eyes.

3. The method of claim 2, further comprising:
generating the iris template from another digital image comprising the face.

4. The method of claim 1, wherein correcting the red eyes further comprises:
performing face recognition to identify a face comprising the red eyes; and
selecting an iris template corresponding to the face based on the identified face, wherein the iris template is used in the restoring.

5. The method of claim 4, further comprising:
detecting a location of the face in the digital image; and
performing face alignment and extraction using the location of the face and the location of the red eyes to produce a normalized face,
wherein performing face recognition further comprises using the normalized face to identify the face.

6. A system for performing automatic red-eye correction on a digital image, the system comprising:
red-eye detection logic configured to detect a location of red eyes in the digital image;
face recognition logic configured to identify a face comprising the red eyes located by the red-eye detection logic; and
red-eye correction logic configured to correct the red eyes in the digital image by restoring the red eyes to their natural color using an iris template corresponding to the face identified by the face recognition logic.

7. The system of claim 6, further comprising:
face alignment and extraction logic configured to use a location of the face in the digital image and the location of the red eyes to normalize the face and provide the normalized face to the face recognition logic.

8. The system of claim 7, further comprising:
face detection logic configured to locate the face in the digital image and provide the location of the face to the face alignment and extraction logic.

9. The system of claim 6, further comprising:
iris template storage configured to store the iris template, wherein the iris template is generated using another digital image comprising the face.

10. The system of claim 6, wherein the iris template is generated using another digital image and the face recognition logic is trained using the another digital image.

11. The system of claim 6, wherein restoring the red eyes to their natural color further comprising replacing pixels in irises of the red eyes with pixels from the iris template.

12. The system of claim 6, wherein the system further comprises image capture logic configured to capture the digital image.

13. The system of claim 6, wherein the system is comprised in a digital camera.

14. The system of claim 6, wherein the system is comprised in a cellular telephone.

15. A digital system for performing automatic red-eye correction in digital images, the digital system comprising:
a processor;
a display; and
a memory storing software instructions, wherein when executed by the processor, the software instructions cause the digital system to perform a method comprising:
accessing a digital image comprising a face;
detecting a location of red eyes in the face;
correcting the red eyes in the digital image by restoring the red eyes to their natural color; and
displaying the corrected digital image on the display.

16. The digital system of claim 15, wherein the method further comprises:
performing face recognition to identify the face; and
selecting an iris template corresponding to the face based on the identified face,
wherein the iris template is used in the restoring.

17. The digital system of claim 16, further comprising:
generating the iris template using another digital image comprising the face.

18. The digital system of claim 16, further comprising:
detecting a location of the face in the digital image; and
performing face alignment and extraction using the location of the face and the location of the red eyes to produce a normalized face,
wherein performing face recognition further comprises using the normalized face to identify the face.

19. The digital system of claim 15, further comprising:
an image capture device for capturing the digital image.

20. The digital system of claim 15, wherein the digital system is one selected from a group consisting of a digital camera, a cellular telephone, a personal digital assistant, a laptop computer, and a personal computing system.
